(19) United States
(12) Patent Application Publication
(10) Pub. No.: US 2024/0069358 A1
(43) Pub. Date: Feb. 29, 2024

(54) GLASSES STRUCTURE

(71) Applicant: ARGUS VISION INTERNATIONAL LIMITED, Tainan (TW)

(72) Inventor: Lin-Yun Chen, Tainan (TW)

(21) Appl. No.: 18/232,322

(22) Filed: Aug. 9, 2023

(30) Foreign Application Priority Data
Aug. 31, 2022 (TW) 111132922

(51) Int. Cl. G02C 1/02; G02C 7/02

(52) U.S. Cl. CPC G02C 1/02; G02C 7/02; G02C 2200/02

(57) ABSTRACT

Provided is a glasses structure, mainly including a frame, two temples, a lens unit and two blocking walls. Both sides of the frames are respectively provided with a first magnetic seat. Each of the temples is pivotally connected to both sides of the frame. The lens unit includes a lens body and a second magnetic seat arranged on both sides of the lens body. Each of the second magnetic seats can be magnetically attracted to each of the first magnetic seats. Each of the blocking walls and both sides of the frame jointly surround two sides of the lens unit. The lens unit is fixed on the frame by means of a magnetic manner, and the lens unit can be detached from the frame such that users can replace the lens unit by themselves.

### BACKGROUND OF THE INVENTION

### 1. Field of the Invention

The present disclosure relates to a pair of glasses, and particularly relates to a glasses structure that adopts the combination and fixation of the frame and the lens by a magnetic manner such that the lens can be operably assembled or detached from the frame so as to facilitate the replacement of the lens.

### 2. The Prior Arts

First of all, with the popularization of glasses, glasses have become one of the equipment in the lives of most modern people. General glasses are roughly divided into optical glasses, sports glasses, sunglasses, etc., for users to choose to wear according to their needs and environments. However, the existing glasses usually only have a single function, and lenses cannot be replaced by themselves. Since the lenses are usually fixed on the frame according to the shape of the frame, one person has multiple glasses with different functions and shapes for replacement, thereby increasing the financial burden on the user.

The few glasses that allow the users to replace the lens by themselves mainly use snap-fitting, fitting or fastening manners to enable the lens to be operatively detached from the frame. However, in the process of disassembly and assembly, a directional force is required to separate the lens or combine with it with the frame. If the force is not applied properly, the lens will be easily worn.

In addition, there is a kind of external magnetic glasses; that is, a secondary lens is attached to the outside of the primary lens of the glasses magnetically. It is common to attach a sunshade lens to the outside of primary optical glasses. Although the glasses have the function of sunshade, it also increases the overall weight of the glasses. In addition, the appearance of the secondary lens often matches the shape of the optical lens, and the shape thereof is relatively unchanged. As such, the existing forms of glasses obviously cannot meet the needs of consumers. How to make it easy for users to replace lenses of glasses has become one of the main problems at present.

### SUMMARY OF THE INVENTION

In view of the shortcomings and deficiencies of the prior art, the present disclosure provides a glasses structure in which the frame and lens are magnetically combined such that the lens can be disassembled and assembled to the frame for easy lens replacement.

In order to achieve the above-mentioned objective, the technical means adopted in the present disclosure is a glasses structure defining a side facing a wearer's face as an inner surface and a side facing an outside as an outer surface, the glasses structure including: a frame respectively arranging a first magnetic seat on both sides thereof, each of the first magnetic seats having a first magnetic element; two temples respectively pivotally connected to two sides of the frame; a lens unit including a lens body and a second magnetic seat positioned on both sides of the lens body, each of the second magnetic seats having a second magnetic element that is mutually magnetically attracted to each of the first magnetic elements, and the lens unit being operable to detach from the frame; and two blocking walls enclosing two sides of the lens unit together with the two sides of the frame respectively.

In the present disclosure, the lens unit is magnetically fixed to the frame such that the lens unit can be operatively detached from the frame without the aid of a tool so as to facilitate the user to replace the lens unit by himself/herself.

### BRIEF DESCRIPTION OF THE DRAWINGS

FIG. 1 is a three-dimensional schematic diagram showing a glasses structure of the present disclosure.

FIG. 2 is an exploded diagram showing the glasses structure of the present disclosure.

FIG. 3 is a partial cross-sectional schematic diagram showing the glasses structure of the present disclosure.

FIG. 4 is a schematic cross-sectional view along line A-A of FIG. 1 according to the present disclosure.

FIG. 5 is a perspective view showing an embodiment of the present disclosure.

FIG. 6 is an exploded schematic diagram showing an embodiment of the present disclosure.

FIG. 7 is a partial cross-sectional schematic diagram showing an embodiment of the present disclosure.

FIG. 8 is a schematic cross-sectional view along line B-B of FIG. 5 according to the present disclosure.

FIG. 9 is a schematic cross-sectional view along line C-C of FIG. 5 according to the present disclosure.

### DETAILED DESCRIPTION OF THE PREFERRED EMBODIMENT

The following is a specific embodiment to illustrate the implementation of the present disclosure. Persons skilled in the art can easily understand the other advantages and effects of the present disclosure from the disclosure in the specification.

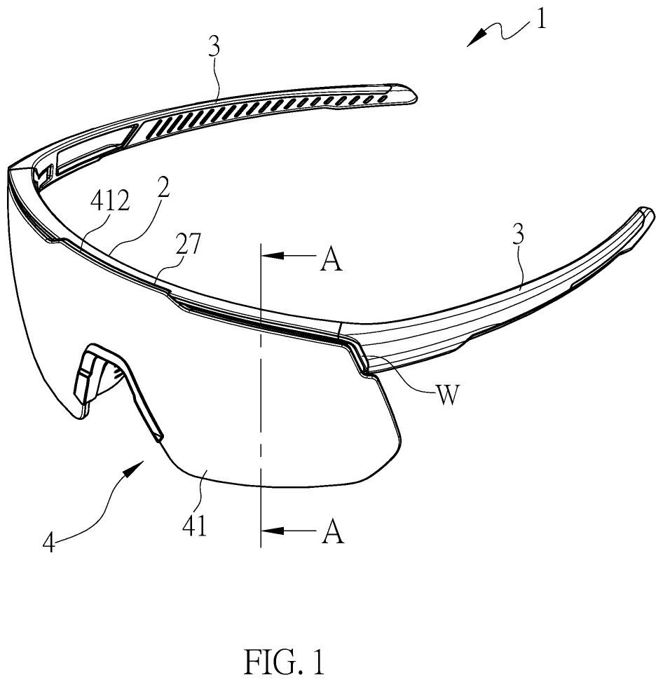

Please referring to FIGS. 1-4, a glasses structure in a preferred embodiment of the present disclosure defines a side facing a wearer's face as an inner surface and a side facing an outside as an outer surface. The glasses structure mainly includes: a frame 2, two temples 3, a lens unit 4 and two blocking walls.

The outer surface 21 of the frame 2 is respectively provided with a first magnetic seat along the length direction to both sides of the frame 2. Each of the first magnetic seats 22 has a first magnetic element 23. In this embodiment, the first magnetic seat 22 is a groove integrally formed by the frame 2. Moreover, each of the first magnetic elements 23 is embedded in the bottom of each of the first magnetic seat 22, but not limited thereto. Alternatively, each of the first magnetic elements 23 may also be attached to each of the first magnetic seat 22 by means of adhesion, locking, coating injection, etc. The frame 2 is further provided with two pivot seats 24. Each of the pivot seats is adjacent to each of the first magnetic seat 22, and each of the pivot seats 24 is preferably integrally formed with the frame 2.

The front end of each of the temples 3 is provided with a pivot portion 31. Each of the temples 3 is pivotally connected to the pivot seat 24 provided on both sides of the frame by the pivot portion 31, and can be pivot relative to the frame 2.

The lens unit 4 includes a lens body 41 and second magnetic seats 42 protruding from both sides of the top edge of the inner surface 413 of the lens body 41. The lens body 41 is frameless, and a nose pad assembly 43 is provided at the bottom of the middle section thereof. Each of the second magnetic seats 42 has a second magnetic element 44 that can be magnetically attracted to each of the first magnetic elements 23. Additionally, the shape of each of the second magnetic seats 42 is matched with each of the first magnetic seats 22. The present disclosure does not limit the manners (e.g., coating injection, bonding, locking, etc.) in which each of the second magnetic seats 42 is attached on the lens body 41. All the manners in which each of the second magnetic seats 42 can be attached to the lens body 41 are within the scope of the present disclosure.

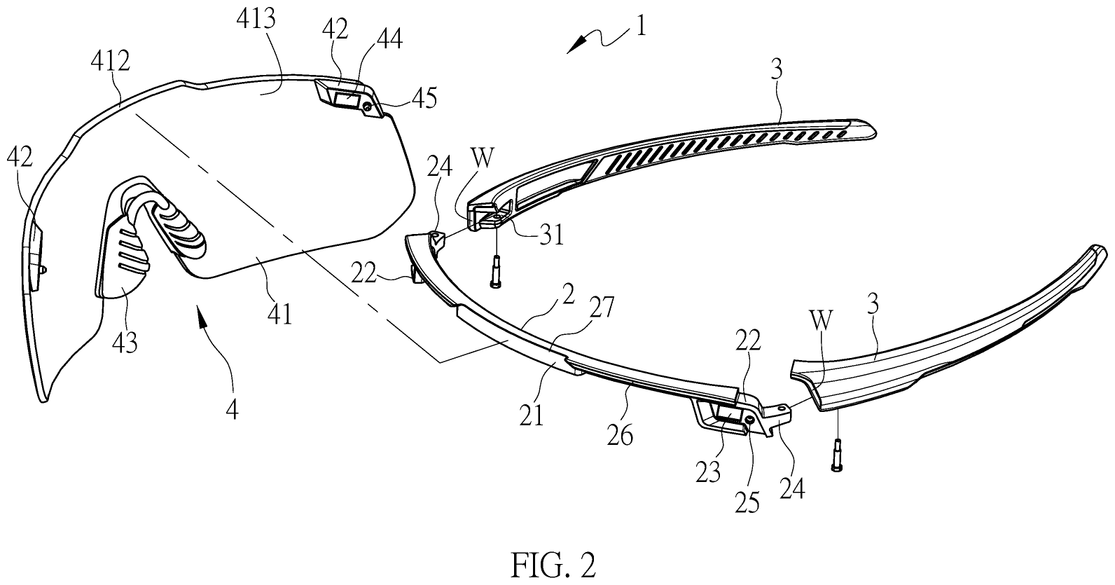

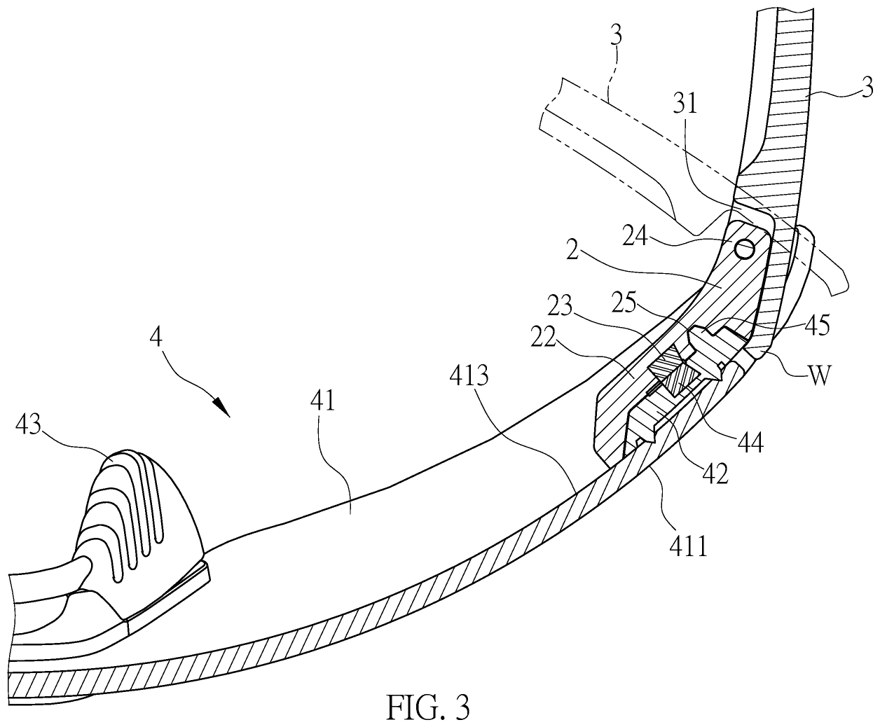

Please refer to FIGS. 2 and 3. One side of each of the second magnetic seats 42 extends out from the periphery of both sides of the lens body 41. The lens unit 4 is embedded in each of the first magnetic seats 22 with each of the second magnetic seats 42, and attached on the frame 2. The lens unit 4 is operably detached from the frame 2 through mutual magnetic attraction. Additionally, the displacement of the lens unit 4 relative to the frame 2 is limited by the embedding manner of each of the first magnetic seats 22 and each of the second magnetic seats 42. In other embodiments, each of the first magnetic seats 22 and each of the second magnetic seats 42 may be replaced by equivalent concavo-convex, which can also achieve the effect of fitting and fixing.

As shown in FIG. 3, each of the blocking walls W is integrally formed with the front end of each of the temples 3. When each of the temples 3 is unfolded, each of the blocking walls W and both sides of the frame 2 jointly surround the two sides of the lens unit 4. In this embodiment, each of the blocking walls W resists the part of each of the second magnetic seats 42 extending out of the lens body 41, but not limited thereto. Alternatively, each of the block walls W can also resist the outer surface 411 of the lens body 41 or simultaneously resist each of the second magnetic seats 42 and the lens body 41. When each temple 3 is folded, each of the blocking walls W moves away from both sides of the lens unit 4 along with each of the temples 3 such that the lens unit 4 can be operatively detached from the frame 2.

Further, each of the first magnetic seats 22 is provided with a positioning slot 25 at intervals of each of the first magnetic elements 23. In addition, each of the second magnetic seats 42 is provided with a positioning column 45 at intervals of each of the second magnetic elements 44. When the lens unit 4 is magnetically attached to the frame 2, each positioning column 45 is embedded in each positioning slot 25.

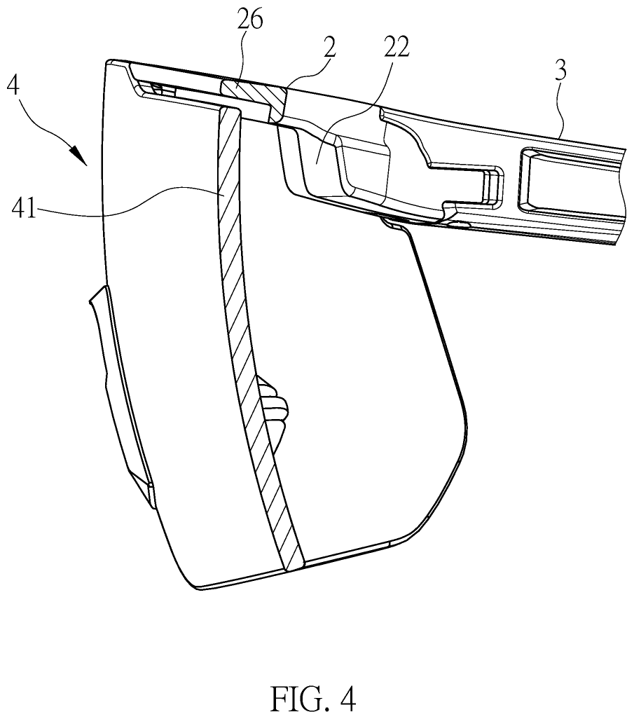

Please refer to FIGS. 2 and 4. A stop portion 26 extends from the top of the frame 2 towards the outer surface thereof. The stop portion 26 is located above the lens body 41, thereby limiting the upward displacement of the lens body 41 relative to the frame 2. The stop portion 26 is provided with a notch 27 at the middle section of the frame 2, and the top of the lens body 41 is provided with a flange 412 matching the notch 27. When the lens unit 4 is magnetically attracted to the frame 2, the flange 412 of the lens body 41 is embedded in the notch 27 of the stop portion 26, thereby limiting the left and right displacement of the lens unit 4 relative to the frame 2 and allowing the lens unit 4 to be firmly arranged on the frame 2. Through structural limitations such as each of the second magnetic seats 42 being embedded in each of the first magnetic seats 22, the stop portion 26 and the flange 412 being embedded in the notch 27, the present disclosure can effectively solve the problem of shaking of the lens unit 4 and the problem of displacement or falling off due to inadvertent touch, thereby improving the structural stability of the glasses 1 and improving the safety of use.

Herein, the lens unit 4 of the present disclosure is magnetically attracted to the frame 2 such that the user can replace the lens unit 4 by himself/herself without the aid of a tool in accordance with the needs of use or matching styles.

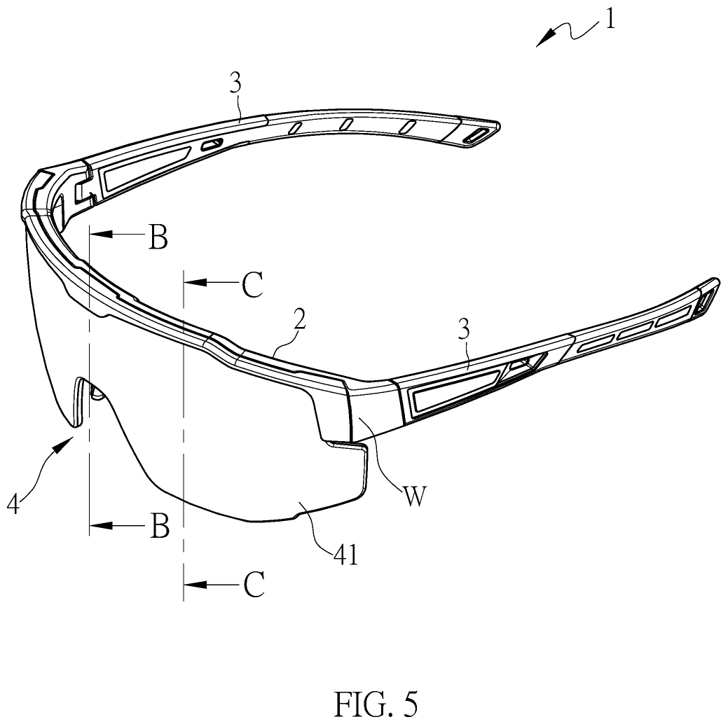

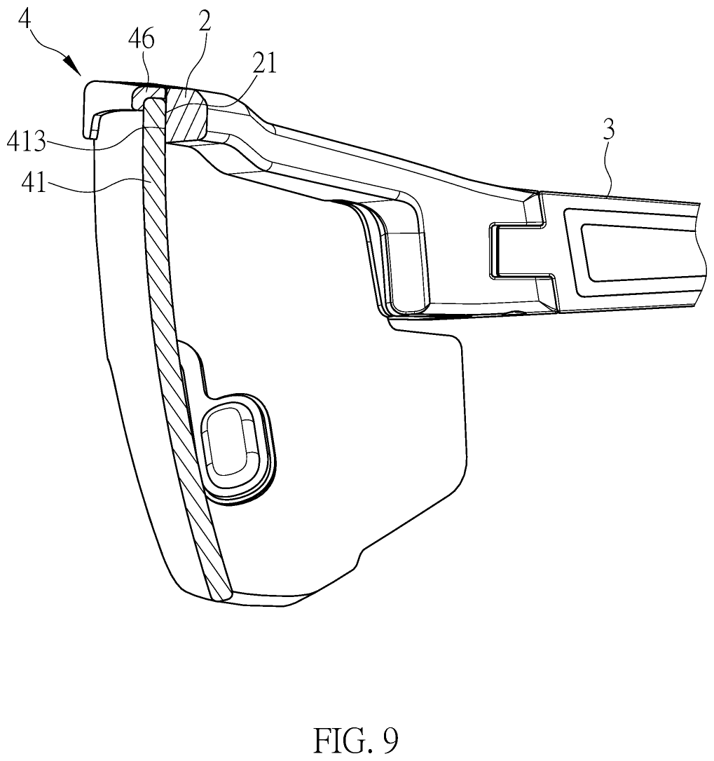

Please refer to FIGS. 5 and 9, which show another embodiment of the present disclosure according to the aforementioned structural changes. In this embodiment, the glasses 1 include: a frame 2, two temples 3, a lens unit 4 and two blocking walls W.

The outer surface 21 of the frame 2 is respectively provided with a first magnetic seat along the length direction to both sides of the frame 2. Each of the first magnetic seats 22 has a first magnetic element 23. In addition, the middle section of the outer surface 21 of the frame 2 is provided with a notch 27. The notch 27 has a third magnetic element 28. A bonding portion 29 is protruded below the notch 27, and a nose pad assembly 43 is provided downward at the boding portion 29. In this embodiment, the nose pad assembly 43 is fixed on the inner surface 291 of the bonding portion 29 in a locking manner. The frame 2 is respectively provided with a pivot seat 24 adjacent to each of the first magnetic seats 22. Each pivot seat 24 is preferably integrally formed with the frame 2.

A pivot portion 31 is provided at the front end of each temple 3. Each temple 3 is pivotally connected to the pivot seat 24 provided on both sides of the frame 2 by the pivot portion 31 so as to be pivotable relative to the frame 2.

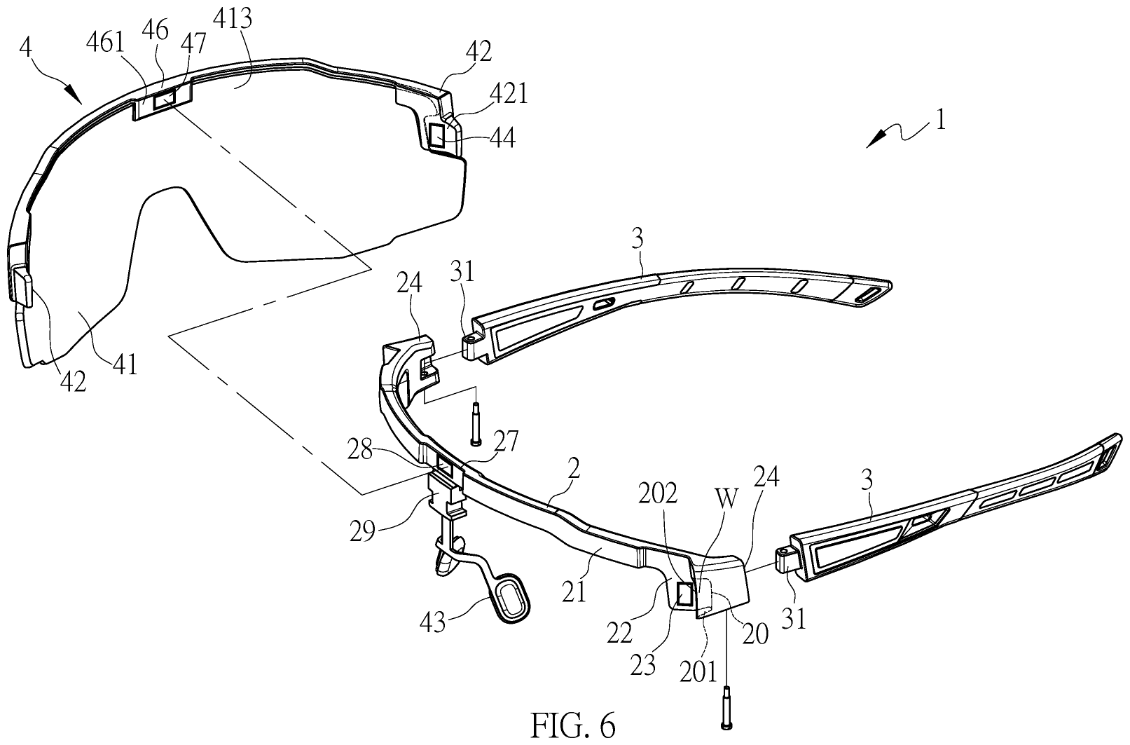

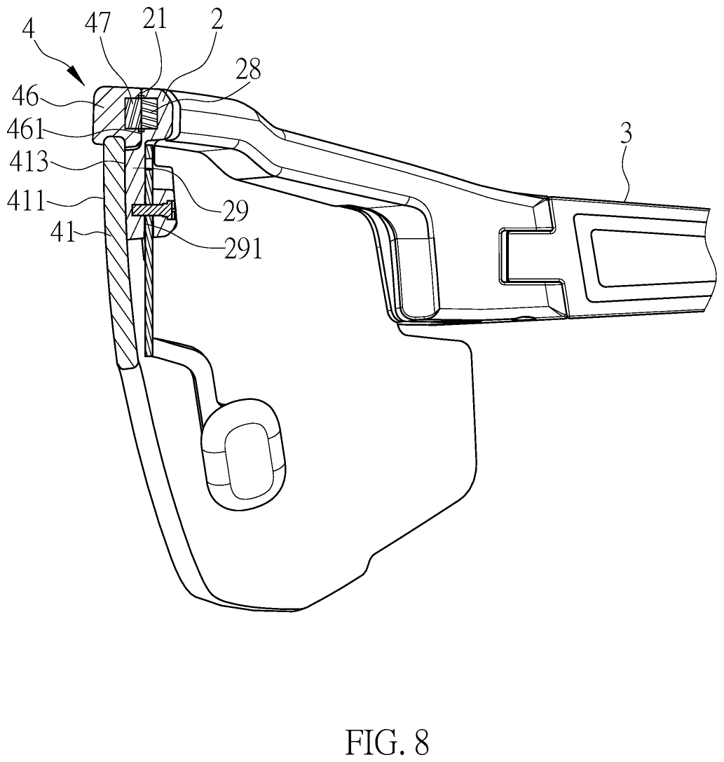

As shown in FIGS. 6 and 8, the lens unit 4 includes a lens body 41 and second magnetic seats 42 arranged on both sides of the lens body 41. The inner surface 421 of each of the second magnetic seats 42 has a second magnetic element 44 that can be magnetically attracted to each of the first magnetic element 23, and a support portion 46 is further provided to connect between the second magnetic seats 42. In this embodiment, the support portion 46 is integrally formed with each of the second magnetic seats 42. A fourth magnetic element 47 is provided at the middle section of the inner surface 461 of the support portion 46, and can be magnetically attracted to the third magnetic element 28. By the setting of each of the second magnetic element 44 and the fourth magnetic element 47, the lens unit 4 is magnetically attracted or operatively detached from the frame 2. Besides, the support portion 46 is partially located above the bonding portion 29, and the downward displacement of the middle section of the support portion 46 can be limited by the bonding portion 29 such that the lens unit 4 can be firmly arranged on the frame 2.

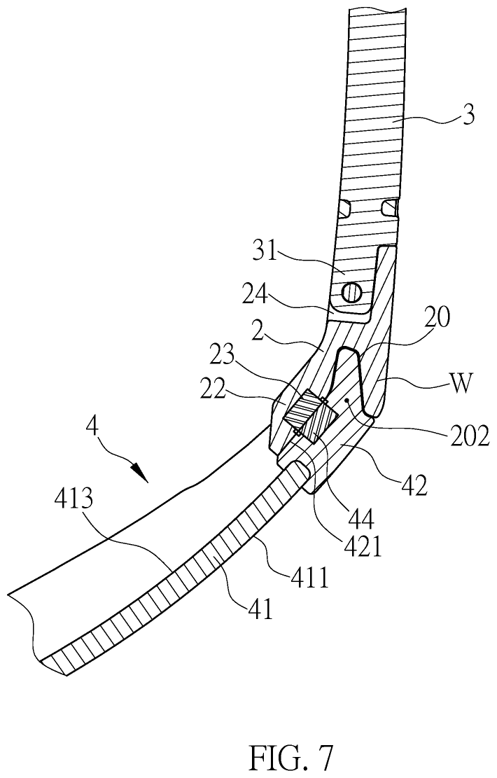

Please refer to FIGS. 6 and 7. In the present embodiment, each of the blocking walls W is integrally formed with both sides of the frame 2, and each of the blocking walls and both sides of the frames 2 jointly define a groove 20 with an opening 201 downward. Each of the grooves 20 has an open end 202 communicating with the groove 20, and each of the open ends 202 is opposite.

The lens unit 4 is partially inserted into the groove 20 from the opening 201 of the groove 20 or embedded into the groove 20 from the open end 202 through each of the second magnetic seats 42 with material elasticity such that each of the first magnetic elements 23 and each of the second magnetic elements 44 are magnetically fixed to each other. In addition, the fourth magnetic element 47 provided on the support portion 46 and the third magnetic element 28 provided at the middle section of the frame 2 are magnetically fixed to each other. As shown in FIGS. 7 and 8, due to the setting of each of the second magnetic seats or the support portion 46, the upper section of the lens unit 4 can be firmly fitted against the outer surface 21 of the frame 2. Alternatively, as shown in FIG. 9, the inner surface 413 of the lens body 41 can fit against the outer surface 21 of the frame 2 so as to prevent the lens unit 4 from shaking when the present disclosure is in use, thereby improving the structural stability of the glasses 1 and improving the safety of use.

When the lens unit 4 is to be replaced, the fourth magnetic element 47 can be operated to disengage from the third magnetic element 28, and subsequently the second magnetic seats on both sides of the lens unit 4 are displaced toward the openings 201 or toward the open ends 202 such that the second magnetic elements 44 are detached from the first magnetic elements 23 and the lens unit 4 can be removed.

To sum up, since the glasses structure of the present disclosure adopts the magnetic manner and the structure that restricts the displacement of the lens unit 4, the user can replace the lens unit 4 without the assistance of tools, thereby achieving the purpose of convenient replacement of the lens unit 4, reducing the burden of purchasing additional glasses and making the glasses of the present disclosure have diversification and better use efficiency.

However, the above-mentioned embodiments are only illustrative to illustrate the effects of the present disclosure, and are not intended to limit the present disclosure. Those skilled in the art can make modifications and changes to the aforesaid embodiments without departing from the spirit and scope of the present disclosure. In addition, the numbers of elements in the above-mentioned embodiments are only for illustrative purposes, and are not intended to limit the present disclosure. Therefore, the scope of protection of rights of the present disclosure should be listed in the claims of the present disclosure below.

What is claimed is:

1. A glasses structure defining a side facing a wearer's face as an inner surface and a side facing an outside as an outer surface, the glasses structure comprising:
a frame respectively arranging a first magnetic seat on both sides thereof, each of the first magnetic seats having a first magnetic element;
two temples respectively pivotally connected to two sides of the frame;
a lens unit including a lens body and a second magnetic seat positioned on both sides of the lens body, each of the second magnetic seats having a second magnetic element that is mutually magnetically attracted to each of the first magnetic elements, and the lens unit being operable to detach from the frame; and
two blocking walls and both sides of the frame jointly surround two sides of the lens unit.

2. The glasses structure of claim 1, wherein each of the blocking walls is integrally formed with a front end of each of the temples, and when each of the temples is folded, each of the blocking walls is away from the two sides of the lens unit along with each of the temples.

3. The glasses structure of claim 1, wherein each of the first magnetic seats is grooved on the outer surface of the frame, each of the second magnetic seats is protruded on the inner surface of the lens body, and each of the second magnetic seats is embedded in each of the first magnetic seats.

4. The glasses structure of claim 1, wherein a stop portion extends from a top of the frame towards the outer surface thereof, and the stop portion is spaced above the lens body.

5. The glasses structure of claim 1, wherein each of the blocking walls is formed integrally with both sides of the frame respectively, each of the blocking walls and both sides of the frame jointly define a downwardly groove, each of the grooves has an open end communicating with the groove, and each of the open ends is opposite.

6. The glasses structure of claim 1, wherein a third magnetic element is provided at a middle section of the frame, the lens unit is provided with a support portion connected between the second magnetic seats, and the support portion is provided with a fourth magnetic element which is magnetically attracted to the third magnetic element.

7. The glasses structure of claim 6, wherein a bonding portion protrudes from the middle section of the frame, and the bonding portion is located below the support portion to limit the downward displacement of the support portion.

8. The glasses structure of claim 1, wherein a nose pad assembly is arranged at a middle section of the lens body.

9. The glasses structure of claim 7, wherein a nose pad assembly is arranged downwards at the bonding portion.

10. The glasses structure of claim 1, wherein each of the first magnetic seat is provided with a positioning slot, and each of the second magnetic seats is provided with a positioning column embedded in each of the positioning slots.
